(19) United States
(12) Patent Application Publication
(10) Pub. No.: US 2016/0379145 A1
(43) Pub. Date: Dec. 29, 2016

(54) Surveillance Data Based Resource Allocation Analysis

(71) Applicant: eConnect, Inc., Las Vegas, NV (US)

(72) Inventors: Henry VALENTINO, III, Las Vegas, NV (US); Jack Coronel, Las Vegas, NV (US)

(21) Appl. No.: 14/752,822

(22) Filed: Jun. 26, 2015

(51) Int. Cl. G06Q 10/06; G06K 9/00; H04N 7/18; G06F 17/30; G06Q 10/10

(52) U.S. Cl. CPC G06Q 10/06311; G06F 17/30575; G06Q 10/105; H04N 7/181; G06K 9/00711

(57) ABSTRACT

Technologies and implementations for facilitating human resource allocation based, at least in part, on analysis of surveillance data are generally disclosed.

### INFORMATION

Unless otherwise indicated herein, the approaches described in this section are not prior art to the claims in this application and are not admitted to be prior art by inclusion in this section.

Video surveillance cameras have become a ubiquitous presence in the world. However, surveillance cameras are typically used as a crime deterrent and for other security purposes. Image data from surveillance cameras is not mined for commercial purposes.

### SUMMARY

Described herein are various illustrative methods for analyzing surveillance data to identify and analyze human resource allocation and to provide recommendations regarding human resource allocation optimization based, at least in part, on the surveillance data. The example method for optimizing human resource allocation includes receiving surveillance data and deriving human resource data from the surveillance data, determining human resource allocation based, at least in part, on analysis of the human resource data, synchronizing the determined human resource allocation with transaction data or context data, or a combination thereof, identifying an optimum human resource allocation based, at least in part, on the synchronized determined human resource allocation and the transaction data or the context data, or the combination thereof and generating a human resource allocation recommendation based, at least in part, on the identified optimum human resource allocation.

The present disclosure also describes various example machine readable non-transitory medium having stored therein instructions that, when executed by one or more processors, operatively enable a device to receive surveillance data and derive human resource data from the surveillance data, determine human resource allocation based, at least in part, on analysis of the human resource data, synchronize the determined human resource allocation with transaction data or context data, or a combination thereof, identify an optimum human resource allocation based, at least in part, on the synchronized human resource data and the transaction data or the context data, or the combination thereof and generate a human resource allocation recommendation based, at least in part, on the identified optimum human resource allocation.

The present disclosure additionally describes example devices that include a processor and a human resource data analysis module (HRDAM) communicatively coupled to the processor, configured to receive surveillance data and derive human resource data from the surveillance data, determine human resource allocation based, at least in part, on analysis of the human resource data, synchronize the determined human resource allocation with transaction data or context data, or a combination thereof, identify an optimum human resource allocation based, at least in part, on the synchronized human resource data and the transaction data or the context data, or the combination thereof and generate a human resource allocation recommendation based, at least in part, on the identified optimum human resource allocation.

The present disclosure additionally describes example devices that include a processor and a human resource data analysis module (HRDAM) communicatively coupled to the processor, configured to receive surveillance data and derive human resource data from the surveillance data, determine human resource allocation based, at least in part, on analysis of the human resource data, synchronize the determined human resource allocation with transaction data or context data, or a combination thereof, identify an optimum human resource allocation based, at least in part, on the synchronized human resource data and the transaction data or the context data, or the combination thereof and generate a human resource allocation recommendation based, at least in part, on the identified optimum human resource allocation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates an example system for human resource allocation analysis based, at least in part, on surveillance data, in accordance with various embodiments;

FIG. 2 illustrates an example system for human resource allocation analysis based, at least in part, on surveillance data, in accordance with various embodiments;

FIG. 3 illustrates an example system to facilitate human resource allocation analysis based, at least in part, on surveillance data;

FIG. 4 illustrates an example system for human resource allocation analysis based, at least in part, on surveillance data;

FIG. 5 illustrates an example system for human resource allocation analysis based, at least in part, on surveillance data;

FIG. 6 illustrates an operational flow for human resource allocation analysis based, at least in part, on surveillance data;

FIG. 7 illustrates an operational flow for human resource allocation analysis based, at least in part, on surveillance data;

FIG. 8 illustrates an example computer program product, arranged in accordance with at least some embodiments described herein;

FIG. 9 illustrates an example operational flow for facilitating identifying human resource allocation and making recommendations based, at least in part, on the identified human resource allocation arrange in accordance with at least some embodiments described herein;

FIG. 10 illustrates an example computer program product 1000, arranged in accordance with at least some embodiments described herein; and

FIG. 11 is an illustration of a block diagram of an example computing device, all arranged in accordance with at least some embodiments described herein.

### DETAILED DESCRIPTION

The following description sets forth various examples along with specific details to provide a thorough understanding of claimed subject matter. It will be understood by those skilled in the art, however that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems related to facilitating identifying human resource allocation and making recommendations based, at least in part, on the identified human resource allocation. As will be apparent from the present disclosure, the recommendations based, at least in part, on the identified human resource allocation may be further drawn and be described with respect to artificial intelligent learning of the human resource allocation (i.e., artificial intelligent learning and/or making recommendations based, at least in part, on the artificial intelligent learning).

Video surveillance has become commonplace. It may be difficult to conduct routine daily business and/or leisure activities without being recorded on video at one or more locations. Private citizens, governmental institutions and/or businesses may record image data for a variety of reasons. Private citizens may record video to ensure personal safety and private property security. Governmental agencies may record video to ensure safety of the citizenry and to ensure compliance with various regulations (e.g., speed limits and other traffic rules). Businesses that deal with the public typically may have at least one or more video recording device located at or near where business transactions may take place such as, but not limited to, at or near a point of sale (POS) device. Similarly, gambling establishments (e.g., casinos), financial establishments (e.g., banks), department stores and other commercial businesses may also position video recording devices at a wide variety of locations (e.g., doors, teller windows, gambling tables, jewelry counters etc.) within a business to act as a deterrent to illegal activities and/or to provide a record of illegal activities taking place on the business premises.

As video surveillance technology has become more sophisticated, more and more video recordings may include digital data comprising image data and/or audio data. Accordingly, surveillance data may be commonly referred to as video data, image data and/or audio data.

There is a great deal of interest in optimizing human resource allocation. Employee compensation is one of the greatest business expenses. Thus, improving the efficiency and productivity of employees is a major concern for many business owners. There may be vast amounts of surveillance data generated by the business, private citizens, governmental institutions, and etc. If accessible, such surveillance data taken on a business' premises may be captured during working hours and may be analyzed to identify employees and customers (e.g., using facial recognition techniques) and their actions. Human resource allocation may be analyzed based, at least in part, on the surveillance data. Recommendations on optimizing human resource allocation may be provided based, at least in part, on the analysis.

In an example, a human resource allocation optimization system may be implemented in a coffee shop having a workspace for making coffee drinks and plating pastries, a point of sale (POS) device located at a counter, and a retail area containing various coffee/tea related merchandise. The coffee shop may be equipped with video cameras for surveillance. The counter, workspace, and retail area in the coffee shop may each be in the field of view of at least one video camera so that most or all employee activity may be monitored during working hours. The video cameras may capture employee-customer interactions as well.

The surveillance data captured by the video cameras may comprise image data and/or audio data. The surveillance data may be sent from the video cameras to a human resource data analysis module (HRDAM), where the human resource data may be derived from the surveillance data. The human resource data may include image data and/or audio data. HRDAM may derive human resource data using various video content analysis (VCA) techniques to identify facial data and/or behavior data. Facial data and/or behavior data may be analyzed by HRDAM to identify employees and/or customers and further to identify actions executed by the employees and/or customers.

In an example, human resource allocation may be determined by HRDAM based, at least in part, on the human resources data. Human resource allocation may include a distribution of employees throughout the coffee shop during various time periods, numbers of customers that are in the coffee shop during those time periods, amount of time customers browse with employee present in the retail area, amount of time customers browse with employees absent the retail area, ratios of customers to employees, ratios of customers in line to employees in the workstation and/or at the counter and/or numbers of customer interactions with employees in the retail area, workstation, counter and/or in line. Additionally, example of human resources allocation behaviors that may be recognized by analysis of human resource data may include atmosphere, ambience, air, mood, feel, situation, culture, character, etc. There may be many other types of human resources allocation behaviors that may be recognized by analysis of human resource data, and the claimed subject matter is not limited to the description herein.

In an example, the POS device may be configured to record and timestamp transaction data. In addition to a transaction time, transaction data may include supplemental information about a purchase such as who made the purchase, age or gender of the customer, income, day of the week, whether any items purchased were a result of an “up sale” or “specials” initiatives, coupons used, whether the item was a sale or discount item, etc. Such transaction data may be sent from the POS to the HRDAM. The HRDAM may be configured to synchronize the human resource data with the transaction data. Context data may also be captured and sent to the HRDAM to be synchronized either along with transaction data and the human resource data or synchronized with the human resource data alone.

In an example, HRDAM may identify an optimum human resources allocation based, at least in part, on the synchronized data. For example, the HRDAM may determine based, at least in part, on the synchronized data, when certain employees are working or interacting with customers in the retail area, sales of retail items may increase. HRDAM may determine that an optimum allocation of such human resources may be to schedule these employees to work in the retail area during the times when there tends to be a greater number of customers spending time in the retail area. For example, after a morning rush when people have more time to browse. Likewise, for example, the HRDAM may determine based, at least in part, on the synchronized data that there may be an optimum ratio of employees to customers. Such a determination may be related to a maximum net profit calculation synchronized with the human resources allocation data and/or other data indicating the number of customers in the coffee shop. An optimum ratio of employees to customers may be employee and/or customer profile specific. For example, at a particular time of day (e.g., right after school) when the majority of the customers in the shop may be young women and men, the optimum employee/customer ratio may be high (e.g., greater than one). Alternatively, continuing with the non-limiting after school example, the optimum ratio of employee/customer for the youthful customer demographic may be higher if the employees also fit the similar demographic. Whereas, if the employees are older than the customers, the optimum employee/customer ratio may be smaller. HRDAM may identify variables that affect the optimum employee/customer ratio based, at least in part, on the human resource data and transaction data or context data, or a combination thereof. In an example, the transaction data may include net profit data. Synchronizing human resource data with the transaction data may further comprise comparing the one or more ratios of employees to customers during one or more time periods with the net profit data for one or more corresponding time periods. Accordingly, in one example, HRDAM 104 may identify human resource allocation optimums based, at least in part, on net profit data.

In another example, HRDAM may identify synergies between employees, where particular employee combinations may work particularly well together and be more efficient than others (i.e., an optimum human resource allocation may comprise employee pairs or groups). Conversely, HRDAM may identify employee combinations that may be particularly inefficient (i.e., an identified optimum human resource allocation that may eschew particular employee pairs or groups.

In an example, HRDAM may synchronize the human resource data and context data to determine optimum human resource distributions that may be context sensitive. For example, weather may have an influence on an optimum employee/customer ratio. HRDAM may determine that when the weather is sunny and warm, the optimum employee/customer ratio may be higher than when the weather is rainy and cool. In another example, the context may be a holiday season, tax day, election day, a day of the week (e.g., Wednesday), and/or a typical payday. HRDAM may determine that such contexts may influence an optimum employee/customer ratio and may identify a track record of optimum employee/customer ratios or other human resource allocation optimums.

In an example, surveillance data may be collected and stored over various time periods such as, but not limited to, days, weeks, months, and/or years. The human resource data may be analyzed over the various time periods and a record of the human resource data synchronized with the transaction data and/or the context data may be stored.

In an example, HRDAM may generate a human resource allocation recommendation based, at least in part, on the identified optimum human resource allocations. For example, HRDAM may generate an employee schedule that optimizes human resource allocation based, at least in part, on the analysis of the human resource data and the synchronized transaction and context data as previously described. Such a schedule may indicate times that particular employees may be recommended to work, locations they may be recommended to work in the coffee shop, and/or with whom they may be recommended to work in order to allocate human resources to an optimum effectiveness and/or efficiency.

In another example, HRDAM may identify behavior between employees and customers, where interactions between an employee and a customer may be considered to be conforming to customer policies and/or culture (e.g., various indications of body language, posture, interactions, language, vocabulary, etc., and/or any combination thereof). Continuing with the non-limiting example of the coffee shop, identifying behavior between employees and customers may include, but not limited to, how often the employee speaks with the customer, level of voice used by the employee, how close the employee is to the customer, how often various vocabulary may be used (e.g., “Thank you”, “You're welcome”, “Please”, “No”, “Yes”, etc.). One example of customer policies and/or culture may include employee/customer interactions that may provide a particular atmosphere, and an example may include how a customer may experience the atmosphere when interacting with an employee(s) at a coffee shop such as, but not limited to, Starbucks Corporation of Seattle, Wash. Another example may include how a customer may experience the atmosphere when interacting with an employee(s) at a retail store such as, but not limited to, Nordstrom, Inc. of Seattle, Wash. For a non-limiting comparison, a customer may experience one atmosphere (i.e., customer policies and/or culture) when interacting with employee(s) at a retail store such as, but not limited to, Nordstrom (i.e., a fashion related retail), while a customer may experience a different atmosphere (i.e., customer policies and/or culture) when interacting with employee(s) at a retail store such as, but not limited to, Recreational Equipment, Inc. of Kent, Wash. (i.e., sporting goods and outdoor gear related retail).

It should be appreciated that the above described non-limiting examples may be but just a couple of examples. For example, a wide variety of employee/customer interaction establishments may be included such as, but not limited to, medical office (e.g., doctor/patient interaction), restaurant, post office, auto dealer, gambling establishments (e.g., casino), accommodation establishments (e.g., hotel), transportation related establishments (e.g., in a commercial airplane, flight attendant/passenger), etc., and/or any combination thereof. Accordingly, those skilled in the art will appreciate that the disclosed subject matter may include a wide variety of applications that may facilitate recognition and/or analysis of human resource data (e.g., atmosphere, ambience, air, mood, feel, situation, culture, character, etc., and/or any combination thereof). Thus, the claimed subject matter is not limited in these respects.

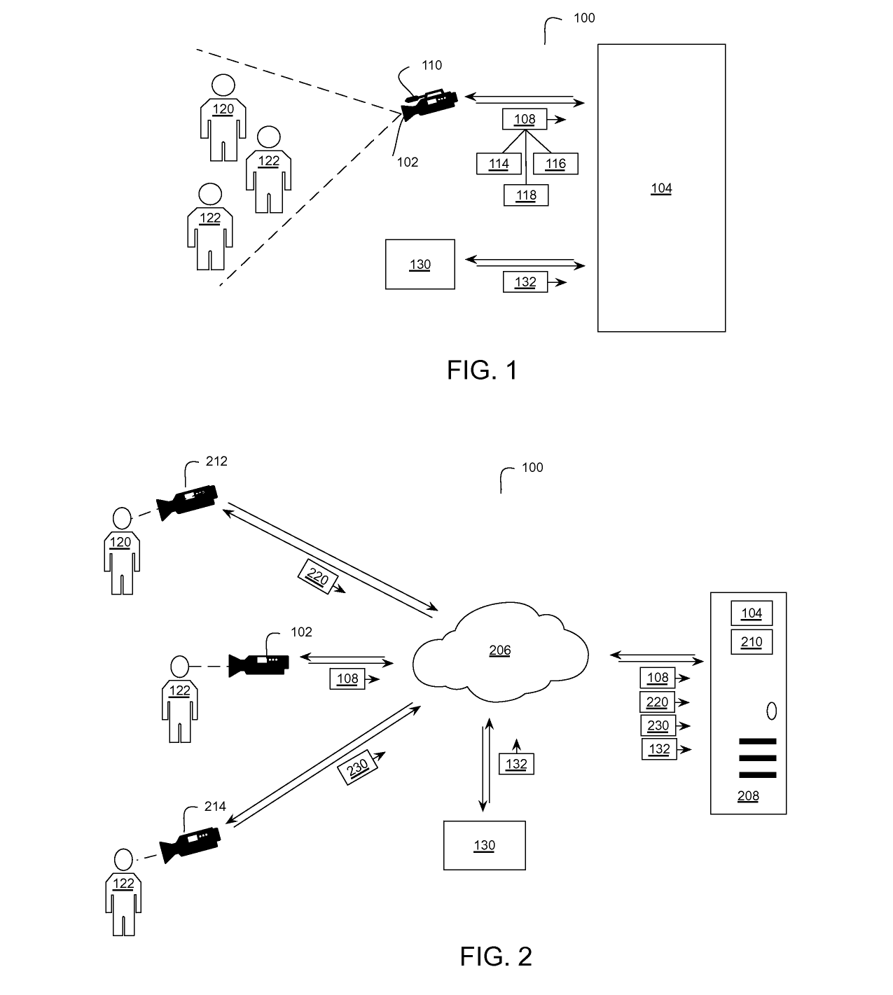

FIG. 1 illustrates an example system for human resource allocation analysis based, at least in part, on surveillance data, in accordance with various embodiments. Shown in FIG. 1, a system 100 may comprise a camera 102 and/or a point of sale (POS) device 130 communicatively coupled to a human resource data analysis module (HRDAM) 104. HRDAM 104 may be disposed in camera 102 or may be remote and communicatively coupled to camera 102 via a wireline and/or wireless communication system. HRDAM 104 may be configured to receive surveillance data 108 from camera 102 and derive human resource data from the surveillance data 108. HRDAM 104 may be further configured to determine human resource allocation based, at least in part, on analysis of the human resource data. HRDAM 104 may be further configured to synchronize the determined human resource allocation with transaction data 132 received from POS device 130. In an example, HRDAM 104 may be configured to identify an optimum human resource allocation based, at least in part, on the synchronized human resource data and the transaction data and generate a human resource allocation recommendation based, at least in part, on the identified optimum human resource allocation. In an example, context data may be synchronized with the human resource data by HRDAM 104 and may be used to identify an optimum human resource allocation.

In an example, camera 102 may comprise a wide variety of imaging devices. Such imaging devices may include, an analog type video camera, a video device utilizing charge-coupled devices (CCD), a video device utilizing complementary metal-oxide semiconductor (CMOS), a thermal imaging device, infrared imaging device, a night vision device, an ultrasound imaging device, a near-infrared imaging device, or the like, and any combination thereof. Camera 102 may include a microphone 110 for recording audio.

In an example, camera 102 may be disposed at a vantage point such that camera 102 may provide surveillance of allocation of human resources within a particular area within the field of view of camera 102. Camera 102 may record images and/or audio of one or more employees 120 and/or customers 122. Employees 120 and/or customers 122 may be participating in various activities such as, but not limited to, working in various capacities in a business, engaging in a transaction at a point of sale (POS) device, entering or leaving a location, browsing merchandise, etc., and/or any combination thereof. Camera 102 may be configured to capture one or more images that include facial features of the one or more employees 120 and/or customers 122 and/or behavior associated with one or more employees 120 and/or customers 122.

In an example, images and/or audio recorded by camera 102 may be stored as surveillance data 108. Camera 102 may send surveillance data 108 to HRDAM 104 for analysis. HRDAM 104 may be configured to receive surveillance data 108 from camera 102 and may perform video content analytics (VCA) on the surveillance data 108 to derive human resource data from the surveillance data 108.

In an example, HRDAM 104 may determine human resource allocation by analyzing the derived human resource data. In order to determine how human resources are allocated in a particular area, HRDAM 104 may be configured to detect and identify facial data 114, behavior data 116, and/or audio data 118, etc., and/or any combinations thereof based, at least in part, on VCA. VCA may include any of a variety of algorithms, applications and/or programs in hardware, firmware and/or software. VCA may be configured to detect audio, facial features, and/or spatial events corresponding to behavior. HRDAM 104 may perform VCA including, audio analysis, facial recognition, shape recognition, motion detection, egomotion estimation, object detection, video tracking, etc. or any combination thereof.

In an example, HRDAM 104 may analyze human resources data to determine human resource allocation by identifying employees, customers and/or behaviors of either party that may relate to allocation of human resources such as, but not limited to, identifying locations the employees and/or customers are occupying within a business, identifying interactions between customers and employees, identifying the employees and customers, etc. Behaviors associated with the one or more employees 120 and/or customers 122 may be captured in image and/or audio data by video camera 102 as spatial events and/or audio events. Such spatial and audio events may include actions executed by the one or more employees 120 and/or customers 122 including engaging in a transaction, an employee 120 handing merchandise to a customer 122, serving or interacting with customers 122, taking payment, up-selling, promoting products, entering a store, leaving a store, browsing merchandise, playing a video game, eating, gambling, exercising, working or the like, and/or any combination thereof. HRDAM 104 may analyze the spatial and audio events, identify behaviors executed by the one or more employees 120 and/or customers 122 and may associate the identified behaviors with identifiers in memory corresponding to the one or more employees 120 and/or customers 122. Behaviors may be inferred from an analysis of motions executed by the one or more employees 120 and/or customers 122 in spatial and audio events. In an example, the motions recorded may be correlated with other contextual factors to make such inferences. Behaviors such as, but not limited to, making a purchase, entering a store, leaving a store, browsing merchandise, playing a video game, eating, gambling, exercising, working, and the like may be inferred from an analysis of motions executed by a subject in surveillance data 108. In an example, the motions recorded may be correlated with audio data and/or contextual factors to make such inferences. The behavior identified may be associated with the one or more employees 120 and/or customers 122 in a database. Each behavior entry may be associated with context data and/or supplemental data that adds information about the behavior such as, but not limited to, a length of time executing the behavior, frequency of the behavior, heat generated during activity, volume of activity, limbs involved, posture or the like, and/or any combination thereof. In one example, behaviors may be identified using a variety of VCA techniques. For example, possible behaviors may be predetermined and identifiable based, at least in part, on a range of motions, which may be generally characteristic of the predetermined behavior. In another example, behaviors may be associated with facial data 114 based, at least in part, on motion analysis and an inferred connection between the body executing the motions and facial data 114. HRDAM 104 may include a database identifying motion characteristics of the predetermined behaviors. HRDAM 104 may be configured to map motion recorded in the surveillance data 108 to one or more of the predetermined behaviors. In an example, VCA may include facial recognition analysis and/or behavior analysis, or any combination thereof. The behavior analysis may be based, at least in part, on the transaction data or the context data, and/or any combination thereof.

In an example, facial data 114 may comprise any data associated with a face. To determine the human resource allocation, HRDAM 104 may detect facial data 114 based, at least in part, on any of a variety of VCA techniques for identifying facial data 114. HRDAM 104 may use detected facial data 114 to identify the one or more employees 120 and/or customers 122. HRDAM 104 may associate facial data 114 with the one or more employees 120 and/or customers 122 in a database based, at least in part, on the identification. Uniforms and or other identifying features may be used to distinguish between employees and customers. Alternatively, in another example, images of employee and/or customer faces may be stored in a database and used to identify the employees and/or customers in the human resources data when conducting human resource allocation analysis.

In an example, behavior data 116 may comprise data associated with a physical and/or spatial event. To determine the human resource allocation, HRDAM 104 may identify behavior data 116 associated with the one or more employees 120 and/or customers 122 based, at least in part, on any of a variety of VCA techniques for identifying behavior data 116. For example, HRDAM 104 may identify behavior data 116 using VCA such as, but not limited to, shape detection and/or motion detection to identify temporal and/or spatial events such as an action executed by the one or more employees 120 and/or customers 122. HRDAM 104 may infer an association between behavior data 116 and the one or more employees 120 and/or customers 122 based, at least in part, on facial data 114. HRDAM 104 may determine that behavior data 116 detected proximate in time and/or space to facial data 114, that may be associated with the one or more employees 120 and/or customers 122, may be also associated with the one or more employees 120 and/or customers 122. Therefore, an action executed by the one or more employees 120 and/or customers 122 such as, but not limited to, picking up a piece of merchandise may be identified as behavior data 116 and may be attributed to the one or more employees 120 and/or customers 122. HRDAM 104 may associate the behavior data 116 with the one or more employees 120 and/or customers 122 in a database based, at least in part, on facial data 114. The identification may be anonymous, where the subject may be identified by a unique ID without personal information associated with the identification. Alternatively, personal information may be associated with the identification of the one or more employees 120 and/or customers 122. Personal information may be obtained through purchase records of transactions associated with the one or more employees 120 and/or customers 122, subscription programs, loyalty programs, etc. and/or any combination thereof. Analysis of behavior data may be based, at least in part, on the transaction data and/or the context data.

In an example, HRDAM 104 may identify audio data 118 associated with the one or more employees 120 and/or customers 122 based, at least in part, on any of a variety of audio analytic and/or VCA techniques for identifying audio data 118. HRDAM 104 may identify a direction and/or audio signature of detected audio data 118. HRDAM 104 may determine that audio data 118 which may be proximate in time and/or space to facial data 114 and may be associated with the one or more employees 120 and/or customers 122 may also be associated with the one or more employees 120 and/or customers 122. Alternatively, HRDAM may identify an audio signature in audio data 118 that may be associated with the one or more employees 120 and/or customers 122. For example, audio data 118 and the one or more employees 120 and/or customers 122 may have been associated in the past or one or more employees 120 and/or customers 122 may provide an audio sample from which a signature may be detected. Therefore, camera 102 may pick-up audio of the one or more employees 120 and/or customers 122 speaking which may be identified as audio data 118 and may be attributed to the one or more employees 120 and/or customers 122 based, at least in part, on a known signature and/or other audio analytics. HRDAM 104 may associate the audio data 118 with the one or more employees 120 and/or customers 122 in a database.

In an example, HRDAM 104 may be configured to synchronize the determined human resource allocation with transaction data 132 received from POS device 130. Transaction data 132 may comprise any data that may be related to transactions executed by POS device 130. For example, transaction data may include purchase price, credit card information, customer identity, a time stamp, itemized list of product and/or services purchased, discounts applied to a purchase, loyalty card information, demographics, home address, income, gender, age, an image of the customer, or etc., and/or any combination thereof. By synchronizing the determined human resource allocation with transaction data 132, HRDAM 104 may correlate or map the transaction data 132 with the determined human resources allocation information to identify the customers associated with particular purchases and/or identify an employee who may have helped make the sale or otherwise interacted with the customer making the purchase. Context data included with the transaction data 132 and/or provided by a separate device may be cross-correlated to the transaction data 132 and the human resource allocation information to facilitate identification of various contexts that may have had an influence on the transaction such as time of day purchase is made, age of the customer, amount of money spent, a set of items purchased, income, gender of customer, other demographics, etc. Context data may be received by HRDAM 104 from any of a variety of devices including the POS device 130, a weather service, a calendar, news service, etc. or any combinations thereof.

In an example, HRDAM 104 may be configured to identify an optimum human resource allocation based, at least in part, on the synchronized human resource allocation information and transaction data 132. In an example, HRDAM 104 may be configured to analyze transaction data 132 to identify indicators of optimum human resource allocation by correlating transaction trends with human resource allocation trends, identifying transactions associated with customer traffic and/or human resource allocation at a time of the transaction, correlating transactions having a highest value with human resource allocations at the time of the transactions, identifying transactions having a highest net profit when taking operating costs including human resources costs into consideration, etc., and/or any combination thereof. Thus, for example, where human resources are highly efficient and/or effective net profit per transaction may reflect the efficiency and/or efficacy of the human resources allocation and may be used as an indicator of human resource allocation optimization. HRDAM 104 may determine methods to optimize human resources through scheduling, staging (i.e., placing people in various areas of the business), and other personal management techniques based, at least in part, on inferences based, at least in part, on the optimum human resource allocation information. In an example, HRDAM 104 may be configured to identify an optimum ratio of employees to customers or an employee specific impact on net profit, or a combination thereof based, at least in part, on the synchronized human resource data and the transaction data or the context data, and/or a combination thereof. Furthermore, when HRDAM may be generating the human resource allocation recommendation, HRDAM 104 may generate an employee schedule configured to optimize human resource allocation based, at least in part, on the optimum ratio of employees to customers or the employee specific impact on net profit based, at least in part, on the synchronized human resource data and the transaction data or the context data, and/or a combination thereof. Generating the human resource allocation recommendation may be based, at least in part, on the behavior analysis. In an example, HRDAM 104 may be configured to identify an optimum human resource allocation by identifying an optimum ratio of employees to customers that may correlate to an increased net profit based, at least in part, on the net profit data. In one example, HRDAM 104 may be configured to identify an optimum human resource allocation by identifying one or more employees based, at least in part, on video content analysis and associating a percentage of net profit with each of the one or more employees to identify an employee specific impact on net profit of the one or more employees. In one example, HRDAM 104 may be configured to identify an employee specific impact on net profit. In another example, this may be based, at least in part, on the context data. In yet another example, HRDAM 104 may be configured to generate the human resource allocation recommendation by generating an employee schedule configured to optimize human resource allocation based, at least in part, on the optimum ratio of employees to customers and/or the employee specific impact on net profit based, at least in part, on the synchronized human resource data.

In an example, context data and/or transaction data may be synchronized with the human resource data by HRDAM 104 and may be used to identify an optimum human resource allocation and/or to generate the recommendation for human resource allocation.

In one example, based, at least in part, on the optimum human resource allocation information, HRDAM 104 may identify an optimum ratio of employees to customers or an employee specific impact on profit and/or net profit, or a combination thereof based, at least in part, on the synchronized human resource data and the transaction data or the context data, or a combination thereof.

In an example, HRDAM 104 may determine one or more methods to optimize human resources through scheduling, staging (i.e., people in various areas of the business), and other personal management techniques based, at least in part, on inferences based, at least in part, on the synchronized human resource allocation information and transaction data 132. HRDAM 104 may generate a human resource allocation recommendation based, at least in part, on the identified optimum human resource allocation. Generating a human resources allocation recommendation may include generating an employee schedule configured to optimize human resource allocation. Such a schedule may be based, at least in part, on the optimum ratio of employees to customers or the employee specific impact on net profit, and/or any combination thereof.

FIG. 2 illustrates an example system for human resource allocation analysis based, at least in part, on surveillance data, in accordance with various embodiments. System 100 may include camera 102, camera 212 and/or camera 214 communicatively coupled to server 208 via network 206. Cameras 102, 212 and/or 214 may be disposed in different geographical locations, in or near a same geographical location, in various locations within a particular business location, in various locations throughout a particular building, or outdoor location or the like, and/or any combinations thereof. Cameras 102, 212 and/or 214 may be standalone imaging and/or audio recording devices, or may be devices that may include image and/or audio recording functionality such as registers, kiosks, computing devices (e.g., desktop computing devices, handheld computing devices, tablets, smart phones, wearable smart devices including glasses, clothing, and the like), various imaging devices including thermal, digital or analog imaging devices, etc., and/or any combination thereof.

In an example, HRDAM 104 may reside in server 208 and may be configured to receive at least one of surveillance data 108 from camera 102, surveillance data 220 from camera 212 or surveillance data 230 from camera 214, and/or any combinations thereof. Cameras 102, 212 and/or 214 may be communicatively coupled to server 208 via a wireline and/or a wireless communication network 206. Network 206 may include any of a variety of networks. Such networks may include, the Internet, World Wide Web, a ubiquitous computing (ubicomp) environment, cloud computing system, Local Area Network (LAN), a Virtual Private Network (VPN), a Wireless Local Area Network (WLAN), a Wide Area Network (WAN), a Personal Area Network (PAN), and/or the like, and/or any combination thereof.

In an example, HRDAM 104 may be coupled to a storage device 210. Storage device 210 may be disposed in HRDAM 104 or may be a separate device. Storage device 210 may include a database. Storage device 210 may be configured to store a variety of data including, surveillance data 108, surveillance data 220, surveillance data 230, metadata related to surveillance data 108, 220, and/or 230, identifiers associated with the one or more employees 120 and/or customers 122, context data, or the like, and/or any combination thereof. Storage device 210 may store data in a variety of data structures known to those of skilled in the art including, trees, hierarchical data structures, maps, lists, sets, arrays, hashs, etc., and/or any combination thereof. Storage device 210 may comprise any of a wide variety of storage types such as, but not limited to, mechanical, optical, electrical, etc., and/or any combination thereof. Additionally, storage device 210 may include machine readable instructions.

In an example, camera 102 may capture surveillance data 108 at a first time, camera 212 may capture surveillance data 220 at a second time, and/or camera 214 may capture surveillance data 224 at a third time. The first, second and third times may all be different times and may be captured consecutively or with a gap in time between each recording of surveillance data 108, surveillance data 220, and/or surveillance data 230.

In an example, HRDAM 104 may perform audio analysis and/or video content analysis on one or more of surveillance data 108, surveillance data 220, and/or surveillance data 230. HRDAM 104 may identify one or more employees 120 and/or customers 122 based, at least in part, on facial data in one or more of surveillance data 108, surveillance data 220, and/or surveillance data 230. HRDAM 104 may index behaviors associated with the one or more employees 120 and/or customers 122 based, at least in part, on behavior data in one or more of surveillance data 108, surveillance data 220, and/or surveillance data 230. HRDAM 104 may identify audio associated with one or more employees 120 and/or customers 122 based, at least in part, on audio data in one or more of surveillance data 108, surveillance data 220, and/or surveillance data 230. HRDAM 104 may categorize behaviors associated with the one or more employees 120 and/or customers 122 based, at least in part, on the facial data, behavior data and/or audio data. The categorize of behavior may include up-selling behavior, customer interactions, serving customer, customer signaling for attention, employee to customer responsive behavior, and the like, and/or any combination thereof. The categories of behavior may each be recognized by HRDAM 104 according to a predetermined pattern of motions and/or sounds recognizable from the surveillance data 108, 220 and/or 230 and/or audio data. HRDAM 104 may be configured to determine human resource allocation based, at least in part, on the surveillance data 108, 220 and/or 230 and/or audio data. In one example, HRDAM 104 may be configured to associate in storage 210 a unique identifier (UID) with the one or more employees 120 and/or customers 122 and/or with a record of identified behaviors, context data and/or audio data.

In one example, HRDAM 104 may be configured to synchronize the determined human resource allocation with transaction data 132 provided from POS device 130 and/or context data. In another example, the context data may be provided with either the transaction data 132 and/or the surveillance data 108, surveillance data 220, and/or surveillance data 230. The context data may include metadata related to the transaction data 132 and/or the context of the transaction such as, but not limited to, demographic information, geographic information, atmospheric information or the like, and/or any combination thereof. HRDAM 104 may be configured to identify an optimum human resource allocation based, at least in part, on the synchronized determined human resource allocation and the transaction data 132 and/or the context data based, at least in part, on the surveillance data 108, surveillance data 220, and/or surveillance data 230. HRDAM 104 may generate a human resource allocation recommendation based, at least in part, on the identified optimum human resource allocation.

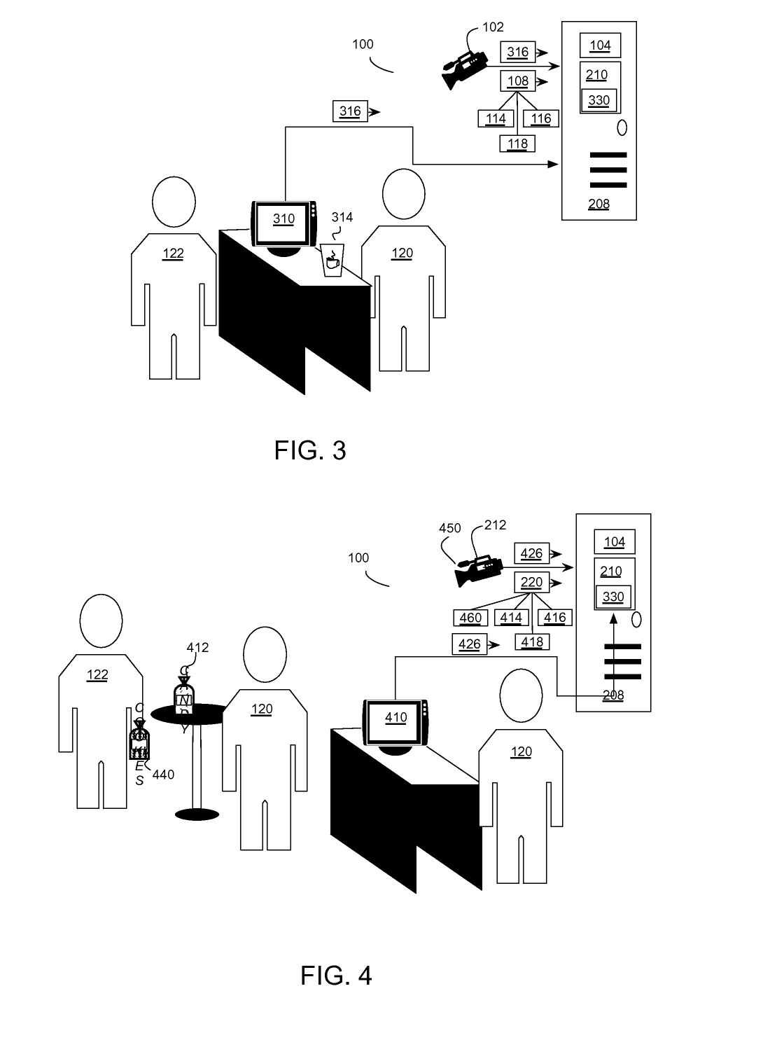

FIG. 3 illustrates an example system for human resource allocation analysis based, at least in part, on surveillance data, in accordance with various embodiments. In one example, system 100 may include camera 102 positioned near a point of sale (POS) device 310 from a viewpoint enabling camera 102 to capture images of the one or more employees 120 and/or customers 122 engaging in a transaction (e.g., the purchase of a cup of coffee 314). Camera 102 may record the purchase and capture surveillance data 108. Surveillance data 108 may include audio, facial data 114 and/or behavior data 116. Camera 102 may be configured to capture and/or generate context data 316 as well. POS device 310 may be configured to capture and/or generate context data 316. Context data 316 may include metadata such as, but not limited to, a camera location, camera ID, time, date, item(s) purchased, time of day, day of the week and/or year, type of establishment in which camera 102 is located, weather information, season, a location, a date, a time, a transaction type, a cost, a product, a service, a weather condition, a duration of visit, a speed, a direction of travel, an entrance, an exit, or a gender etc., and/or any combination thereof. In an example, HRDAM 104 may be disposed in server 208 and may be communicatively coupled with camera 102. Camera 102 may provide HRDAM 104 surveillance data 108. Camera 102 and/or POS device 310 may provide HRDAM 104 context data 316 via a wireless and/or wireline communication medium. Communication may be over a network.

In one example, HRDAM 104 may receive and analyze surveillance data 108 and/or context data 316 to derive human resource data. In another example, human resources data may comprise facial data 114, behavior data 116 or audio data 118, any combination thereof. Analytics performed by HRDAM 104 to derive human resources data may include any of a variety of artificial intelligence algorithms and/or video content analytics (VCA) including, but not limited to, audio analysis, facial recognition, shape recognition, motion detection, egomotion estimation, object detection, video tracking, or the like, and/or any combination thereof. HRDAM 104 may identify one or more employees 120 and/or customers 122 and index behavior data 116 based, at least in part, on the analytics. HRDAM may identify certain behaviors as significant human resources behaviors such as, but not limited to, interactions between employees and customers. In one example, HRDAM 104 may generate a unique identifier (UID) 330 and associate UID 330 with one or more employees 120 and/or customers 122. HRDAM 104 may store UID 330 in a database in storage device 210. HRDAM 104 may associate identified facial data 114 with one or more employees 120 and/or customers 122. HRDAM 104 may associate the indexed behavior data 116 with one or more employees 120 and/or customers 122 based, at least in part, on the facial data 114 or other facets of the surveillance data 108. HRDAM 104 may be configured to associate context data 316 with one or more employees 120 and/or customers 122 based, at least in part, on audio data 118, facial data 114 and/or behavior data 116. HRDAM 104 may associate behavior data 116 with context data 316 to show a relationship of the indexed behavior data 116 to a particular context.

As depicted in FIG. 3, camera 102 may capture images of the one or more customers 122 buying a cup of coffee 314 on Feb. 6, 2015 after 5:00 pm during rainy weather. In this example, HRDAM 104 may receive surveillance data 108 showing the purchase and/or context data 316 identifying the location of the purchase, the item purchased, the date, the time of day, and the weather. HRDAM 104 may derive the human resource data by identifying one or more employees 120 who helped a customer 122 based, at least in part, on facial data 114 from surveillance data 108. HRDAM 104 may derive the human resources data by identifying the behavior data 116 and indexing (e.g., categorizing) the behavior as a “customer service activity” based, at least in part, on behavior data 116 and/or context data 316. HRDAM 104 may be configured to identify the item purchased (e.g., a cup of coffee) based, at least in part, on behavior data 116 (e.g., using object recognition), and/or context data 316 (e.g., using metadata from POS device 310 identifying the item purchased). In one example, HRDAM 104 may derive human resources data by associating the behavior “customer service activity” with one or more employees 120 based, at least in part, on facial data 114. HRDAM 104 may associate the date, Feb. 6, 2015 with behavior data 116 and/or one or more employees 120 based, at least in part, on the context data 316. In another example, HRDAM 104 may perform analytics on surveillance data 108 and/or context data 316 over the course of minutes, hours, days, weeks and/or longer time periods to identify human resource data corresponding to one or more employees 120. In yet another example, HRDAM 104 may be configured to identify one or more employees in the surveillance data, identify one or more customers in the surveillance data and/or determine one or more ratios of employees to customers during one or more time periods.

In an example, HRDAM 104 may analyze the human resources data to determine human resource allocation. To determine human resource allocation, HRDAM 104 may take the human resources data comprising facial data 114, behavior data 116 and/or audio data 118 and may apply analytics to determine where, when, and by whom human resources may be allocated in a business. Analysis of the human resources data by 104 may result in identifying when and where in the business one or more employees 120 may be or may have been stationed when carrying out various human resources activities, what those human resources activities may be the identity of one or more employees 120, what merchandise may have been sold, etc. For example, HRDAM 104 may determine that one employee 120 provided “customer service activity” by aiding customer 122's purchase of coffee 314 on February 6 from behind the counter. Such activity may be associated with an employee 120 by HRDAM 104. HRDAM 104 may identify whether or not additional items may have been purchased along with the coffee as a result of an employee 120 “customer service activity”. Accordingly, a record of human resource allocation may be compiled based, at least in part, on the human resources data.

In one example, human resources allocation information may be compiled and/or synchronized with transaction data 132 and/or context data 316 to determine an optimum human resource allocation.

FIG. 4 illustrates an example system for human resource allocation analysis based, at least in part, on surveillance data, in accordance with various embodiments. Shown in FIG. 4, system 100 may include camera 212, which may be focused on a different geographical location from camera 102. For example, camera 102 may have a sales counter in its field of view while camera 212 may have a retail section in its field of view or cameras 102 and 212 may be disposed in different merchandise departments of the same store, or the like, and/or any combination thereof.

In one example, camera 212 may be positioned at a viewpoint enabling camera 212 to capture images of one or more employees 120 engaging in a “customer service activity” helping customers 122 select merchandise. For example, as depicted in FIG. 4, one or more employees 120 may be assisting one or more customers 122 to select cookies 440 and/or candy 412 in a retail section of a coffee shop. Camera 212 may record an employee 120 engaging in the “customer service activity” and may capture the “customer service activity” in surveillance data 220. Surveillance data 220 may include audio or other sensor data 418, facial data 414 and/or behavior data 416. Camera 212 may be configured to capture and/or generate context data 426. POS device 410 may be configured to capture and/or generate context data 426 along with transaction data when a customer 122 makes a purchase of the candy 412 and/or cookies 440. In another example, HRDAM 104 may be disposed in server 208 and may be communicatively coupled with camera 212. Camera 212 may provide HRDAM 104 surveillance data 220. Camera 212 and/or POS device 410 may provide HRDAM 104 context data 426 and/or transaction data 132 via a wireless and/or wireline communication medium. Communication may be over a network, which may include a wide variety of networks.

In one example, HRDAM 104 may receive and analyze surveillance data 220 to identify human resource data and to determine human resource allocation based, at least in part, on the human resource data. HRDAM 104 may perform analytics over time on surveillance data 108 and/or surveillance data 220 to determine human resource allocations over time and to identify trends in human resource allocation. HRDAM 104 may use the determined human resource allocation to identify optimum human resource allocation information such as, but not limited to, employee activities that may results in sales, employees engaged in activities that may result in sales or increase net profit, etc. HRDAM 104 may synchronize transaction data and context data with human resource data to determine optimum human resource allocations and may generate a recommendation based, at least in part, on the optimum human resource allocation information such as, but not limited to, a schedule.

In one example, surveillance data 220 may comprise sensor data 460. For example, one or more sensors 450 may be positioned throughout an area where human resource data may be gathered. A sensor 450 may be a microphone, heat sensor, optical sensor, infrared (IR) sensor, chemical sensor, pressure sensor, and the like, and/or any combination thereof. The one or more sensors 450 may be disposed anywhere. A sensor 450 may be configured to sense various sensory inputs such as, but not limited to, touch, heat, sound, smell, electromagnetic radiation, infrared radiation, etc., and/or any combination thereof. Sensor 450 may collect and provide (wirelessly and/or via wireline) surveillance data 220 including sensor data 460 to HRDAM 104 for analysis as described above. Sensor data 460 may be analyzed to identify human resource data. Illustrated in FIG. 4, sensor 450 may be a microphone and may be disposed on camera 212. For example, sensor 450 may pick-up audio generating audio sensor data 460. Such sensor data 460 may be used by HRDAM 104 to identify various features of events occurring within a business such as, but not limited to, identifying from ambient noise a number of customers in the business and/or identifying via a voice signature the identity of an employee working and/or a customer present. Sensor data 460 may be monitored to identify patterns in ambient noise fluctuations to facilitate determination of correlations to events so that based, at least in part, on the observed fluctuations in ambient noise, information about activity in the business may be determined by HRDAM 104. For example, the noise level at a party tends to increase overall just before everyone begins to leave. Similarly, an early morning coffee rush may have a high ambient noise level due to frenetic customers clamoring for coffee and breakfast pastries. Noise levels may increase in a business where human resources may not be adequately allocated because customers may have to be louder in order to get their needs met. Such information may be used by HRDAM 104 to generate recommendations about optimum human resource allocation to ensure adequate customer service may be provided during busier times of day. In another example, a large lunch crowd may have less ambient noise with the same number of customers in the store because lunch patrons may be more subdued at the noon hour than morning patrons. Observed patterns in ambient noise levels coupled with context data such as, but not limited to, day and time information may facilitate HRDAM 104 to determine particular human resource needs based, at least in part, on sensor data 460 that may be mapped to context for a sophisticated understanding of human resource needs. Other sensor data such as ambient temperature readings and/or chemical sensors sensitive to human stress hormones may be monitored in a similar way and such data may be analyzed by HRDAM 104 to determine human resource allocation needs and optimization recommendations, in accordance with various embodiments.

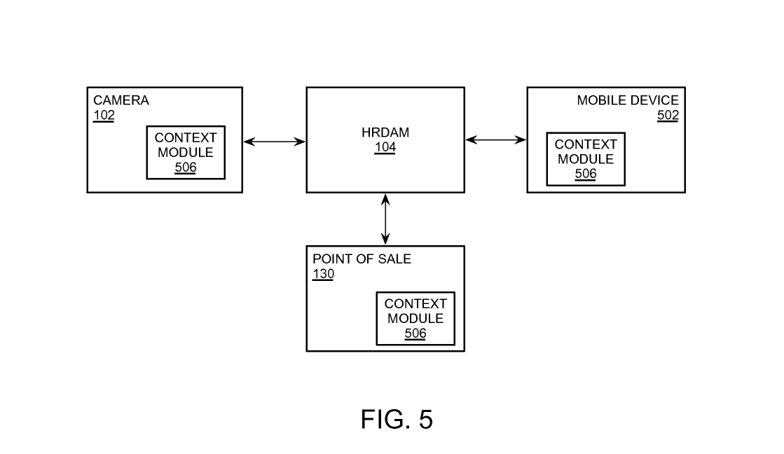

FIG. 5 is a block diagram illustrating an example system for human resource allocation analysis based, at least in part, on surveillance data, in accordance with various embodiments. In an example, system 100 may include a camera 102, HRDAM 104, mobile device 502, and POS device 130. Mobile device 502 may be associated with one or more employees 120 and/or customers 122 in a database accessible to HRDAM 104 or in a database stored in storage device 210 in HRDAM 104. In one example, one or more of camera 102, mobile device 502, or POS device 130 may comprise a context module 506. Context module 506 may be configured to capture context data and provide context data to HRDAM 104 to be analyzed with surveillance data 108. Context data may include one or more of a device location, a device ID, a time, a date, an item purchased, a type of establishment, weather information, a season, a transaction type, a cost, a product, a service, a duration of visit, a speed, a direction of travel, an entrance, an exit, or a gender, and/or any combination thereof. Context module 506 may receive or generate context data based, at least in part, on any of a variety of sources such as, but not limited to, onboard and/or network resources. Context data may be derived from sensors, global positioning satellite communications, a time keeper, a calendar, a weather forecast service, traffic data service, newsfeed, and the like, and/or any combination thereof.

In one example, HRDAM 104 may be configured to send a command requesting context data to any of a variety of devices including but not limited to a point of sale device, small-form factor portable (or mobile) electronic device such as a cell phone, a personal data assistant (PDA), a personal media player device, a wireless web-watch device, a personal headset device, an application specific device, a personal computer, laptop, tablet, slate device etc. Any of such devices may be associated with one or more employees 120 and/or customers 122 in storage device 210. For example, HRDAM 104 may provide a command to POS device 130, mobile device 502 and/or camera 102 requesting context data. The command may trigger POS device 130 to provide the context data to HRDAM 104.

The present disclosure may have been described with respect to non-limiting examples of human resource allocation and/or in the context of an employee and customer interaction. However, it is well contemplated within scope and spirit of claimed subject matter that the present disclosure may be described and may be applicable to a wide variety of consumer and/or merchant related applications as well.

In one example, based, at least in part, on an analysis of surveillance data, human resource allocation may have an effect on a supplier of goods and/or services to a merchant, which may provide the goods and/or services to a customer (e.g., consumer). For example, a supplier may utilize human resource allocation data to determine supply chain related information for the merchant. Based, at least in part, on an optimum human resource allocation information such as, but not limited to, the merchant may determine goods and/or services, which seem to “move” (e.g., sell and/or be popular) for a particular human resource allocation. For example, the particular human resource allocation may indicate that particular goods and/or service move more than other human resource allocations. Perhaps a particular employee and/or employees may be able to move a particular goods and/or services more readily than other employee and/or employees. Accordingly, the supplier may supply more of the particular goods and/or services for the merchant during times when the particular employee and/or employees may be working. Turning back to the non-limiting example of a coffee shop, data seems to indicate that a particular employee seems to be able to sell more lemon pound cake. A supplier of lemon pound cake may increase the quantity of lemon pound cake for the days when the particular employee is on duty. As may be appreciated, a supply chain associated with the lemon pound cake may also be affected. For example, the lemon pound cake supplier may increase ordering of the lemon pound cake ingredients such as, but not limited to, flour, sugar, milk, egg, etc., and/or any combination thereof.

Continuing with the non-limiting example of the coffee shop, the coffee shop may determine that a higher profit may be made from lemon pound cake, and accordingly, the coffee shop may schedule the particular employee (i.e., the employee, who seems to be able to sell more lemon pound cake) on particular days when moving lemon pound cake and/or increasing profit from lemon pound cake may be a priority. It follows that in another example, a customer may have an affinity for lemon pound cake. The coffee shop may have the capabilities of providing communications to the customer. The communications may include a coupon and/or at least a notification that lemon pound cake may be readily available on certain days. The certain days may coincide with the days when the particular employee may be working.

As may be appreciated, human resource allocations may be applicable and/or be utilized for a wide variety of applications within the scope and spirit of present disclosure, and accordingly, within the scope of the claimed subject matter.

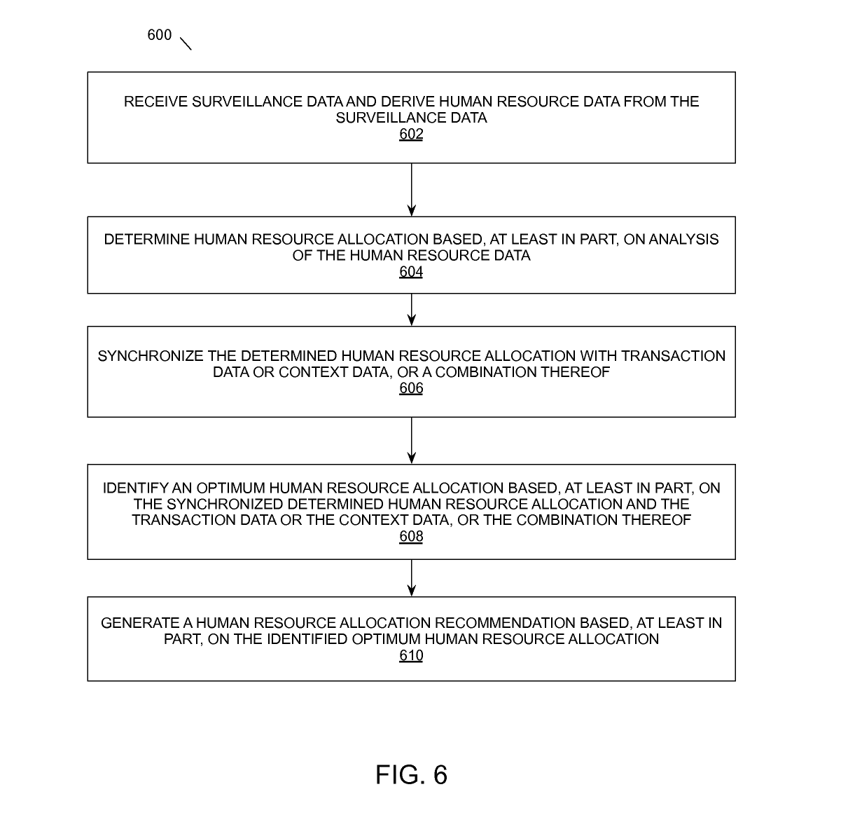

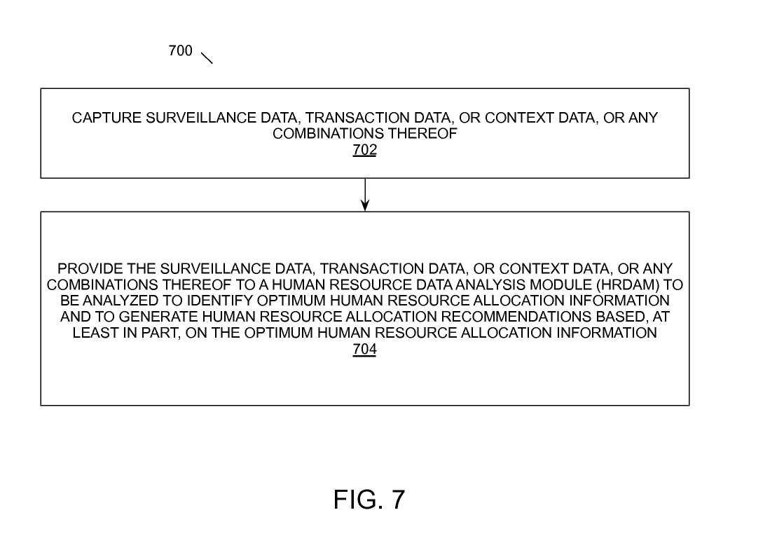

FIGS. 6 and 7 illustrate examples of operational flows for human resource allocation analysis based, at least in part, on surveillance data, arranged in accordance with at least some embodiments described herein. In some portions of the description, illustrative implementations of the method are described with reference to elements of the system 100 depicted in FIGS. 1-5. However, the described embodiments are not limited to these depictions. More specifically, some elements depicted in FIGS. 1-5 may be omitted from some implementations of the methods details herein. Furthermore, other elements not depicted in FIGS. 1-5 may be used to implement example methods detailed herein.

Additionally, FIGS. 6 and 7 employ block diagrams to illustrate the example methods detailed therein. These block diagrams may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In FIG. 6, in some examples, operational flow 600 may be employed as part of a system for human resource allocation analysis based, at least in part, on surveillance data. Beginning at block 602 (“receive surveillance data and derive human resource data from the surveillance data”), HRDAM 104 (shown in FIG. 1) may receive surveillance data 108 comprising sensor data, video image data and/or audio data. The surveillance data 108 may be received from one or more devices capable of capturing sensor data, video image data and/or audio data such as, but not limited to, sensor 450, camera 102, camera 212 and/or camera 214. HRDAM 104 may perform analytics on the surveillance data 108 to derive human resource data as previously described.

Continuing from block 602 to 604 (“determine human resource allocation based, at least in part, on analysis of the human resource data”), HRDAM 104 may perform analytics on the human resource data to determine human resource allocation of the one or more employees 120.

Continuing from block 604 to 606 (“synchronize the determined human resource allocation with transaction data or context data, or a combination thereof”), the HRDAM 104 may synchronize the determined human resource allocation with transaction data or context data, and/or a combination thereof. Continuing from block 606 to 608 (“identify an optimum human resource allocation based, at least in part, on the synchronized determined human resource allocation and the transaction data or the context data, or the combination thereof”), HRDAM 104 may identify an optimum human resource allocation based, at least in part, on the synchronized determined human resource allocation and the transaction data or the context data, and/or the combination thereof. Continuing from block 608 to 610 (“generate a human resource allocation recommendation based, at least in part, on the identified optimum human resource allocation”), HRDAM 104 may generate a human resource allocation recommendation such as, but not limited to, a working schedule or staging based, at least in part, on the identified optimum human resource allocation.

In FIG. 7, in some examples, operational flow 700 may be employed as part of a system for human resource allocation analysis based, at least in part, on surveillance data according to various embodiments of the disclosure herein. Beginning at block 702 (“capture surveillance data, transaction data, or context data, or any combination thereof”), in one example, a device configured to record surveillance data, transaction data, or context data, and/or any combination thereof (e.g., example camera 102) may capture surveillance data, transaction data, or context data, and/or any combination thereof. Surveillance data may include, but not limited to, video data, audio data and/or sensor data or any combinations thereof. Continuing from block 702 to 704 (“send the surveillance data, transaction data, or context data, or any combinations thereof to a human resource data analysis module (HRDAM) to be analyzed to identify optimum human resource allocation information and to generate human resource allocation recommendations based, at least in part, on the optimum human resource allocation information”), in an example, camera 102 may be configured to send surveillance data, transaction data and/or context data to HRDAM 104 to be analyzed to identify optimum human resource allocation information and to generate human resource allocation recommendations based, at least in part, on the optimum human resource allocation information. Surveillance data, transaction data and/or context data may be captured and provided to HRDAM 104 by various devices. In one example, camera 102 may include a context module 506 configured to capture context data from any of a variety of sources such as, but not limited to, an onboard and/or network resources such as a time keeper, a calendar, a weather forecast service, traffic data service, global positioning service, newsfeed, and the like, and/or any combination thereof.

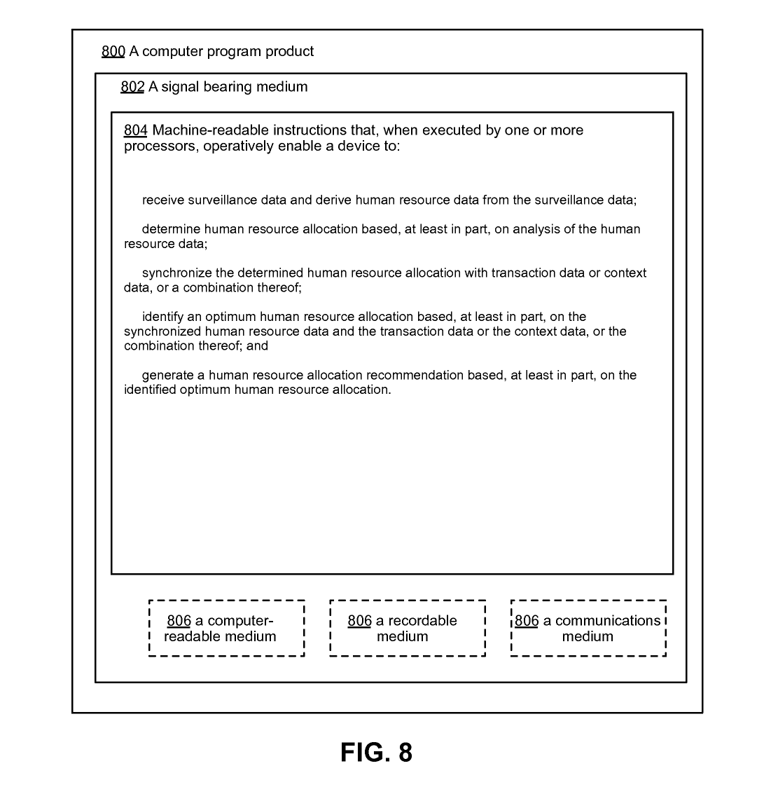

In general, the operational flow described with respect to FIGS. 6 and 7 and elsewhere herein may be implemented as a computer program product, executable on a wide variety of suitable computing system, or the like. For example, a computer program product for facilitating visual analysis of transactions utilizing analytics may be provided. Example computer program products may be described with respect to FIG. 8 and elsewhere herein.

FIG. 8 illustrates an example computer program product 800, arranged in accordance with at least some embodiments described herein. Computer program product 800 may include machine readable non-transitory medium having stored therein instructions that, when executed, cause the machine to facilitate determination of human resource allocation and to make recommendations based, at least in part, on the determined human resource allocation according to the processes and methods discussed herein. Computer program product 800 may include a signal bearing medium 802. Signal bearing medium 802 may include one or more machine-readable instructions 804, which, when executed by one or more processors, may operatively enable a computing device to provide the functionality described herein. In various examples, some or all of the machine-readable instructions may be used by the devices discussed herein.

In some examples, the machine readable instructions 804 may include receiving surveillance data and deriving human resource data from the surveillance data. In some examples, the machine readable instructions 804 may include determining human resource allocation based, at least in part, on analysis of the human resource data. In some examples, the machine readable instructions 804 may include synchronizing the determined human resource allocation with transaction data or context data, or a combination thereof. In some examples, the machine readable instructions 804 may include identifying an optimum human resource allocation based, at least in part, on the synchronized determined human resource allocation and the transaction data or the context data, or the combination thereof. In some examples, the machine readable instructions 804 may include generating a human resource allocation recommendation based, at least in part, on the identified optimum human resource allocation.

In some implementations, signal bearing medium 802 may encompass a computer-readable medium 806, such as, but not limited to, a hard disk drive, a Compact Disc (CD), a Digital Versatile Disk (DVD), a digital tape, memory, etc. In some implementations, the signal bearing medium 802 may encompass a recordable medium 808, such as, but not limited to, memory, read/write (R/W) CDs, R/W DVDs, etc. In some implementations, the signal bearing medium 802 may encompass a communications medium 810, such as, but not limited to, a digital and/or an analog communication medium (e.g., a fiber optic cable, a waveguide, a wired communication link, a wireless communication link, etc.). In some examples, the signal bearing medium 802 may encompass a machine readable non-transitory medium.

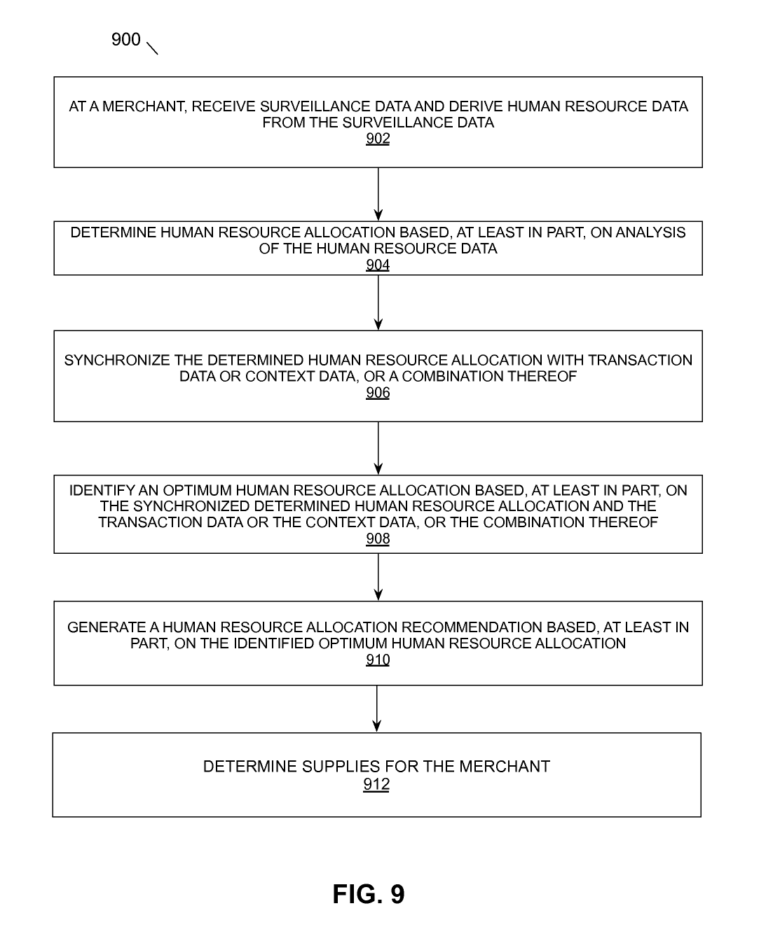

FIG. 9 illustrates an example operational flow for facilitating identifying human resource allocation and making recommendations based, at least in part, on the identified human resource allocation arrange in accordance with at least some embodiments described herein. In some portions of the description, illustrative implementations of the method may be described with reference to components of the system 100 illustrated in FIGS. 1-4. However, the described embodiments are not limited to these illustrations. More specifically, some elements illustrated in FIGS. 1-4 may be omitted from some implementations of the method detailed herein. Furthermore, other components not depicted in FIGS. 1-4, may be used to implement example methods detailed herein.

Additionally, FIG. 9 employ block diagrams to illustrate the example methods detailed therein. The block diagram may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In FIG. 9, in some examples, operational flow 900 may be employed as part of a system for determining supplies for a merchant based, at least in part, on human resource allocation analysis based, at least in part, on surveillance data. Beginning at block 902 (“At A Merchant, Receive Surveillance Data and Derive Human Resource Data From The Surveillance Data”), HRDAM 104 (shown in FIG. 1) may receive surveillance data 108 comprising sensor data, video image data and/or audio data. The surveillance data 108 may be received from one or more devices capable of capturing sensor data, video image data and/or audio data such as, but not limited to, sensor 450, camera 102, camera 212 and/or camera 214. HRDAM 104 may perform analytics on the surveillance data 108, which may facilitate in the artificial intelligence learning by the HRDAM, to derive human resource data as previously described.

Continuing from block 902 to 904 (“Determine Human Resource Allocation Based, At Least In Part, On Analysis Of The Human Resource Data”), HRDAM 104 may perform analytics on the human resource data to determine human resource allocation of the one or more employees 120.

Continuing from block 904 to 906 (“Synchronize The Determined Human Resource Allocation With Transaction Data Or Context Data, Or A Combination Thereof”), the HRDAM 104 may synchronize the determined human resource allocation with transaction data or context data, and/or a combination thereof. Continuing from block 906 to 908 (“Identify An Optimum Human Resource Allocation Based, At Least In Part, On The Synchronized Determined Human Resource Allocation And The Transaction Data Or The Context Data, Or The Combination Thereof”), HRDAM 104 may identify an optimum human resource allocation based, at least in part, on the synchronized determined human resource allocation and the transaction data or the context data, and/or the combination thereof. Continuing from block 908 to 910 (“Generate A Human Resource Allocation Recommendation Based, At Least In Part, On The Identified Optimum Human Resource Allocation”), HRDAM 104 may generate a human resource allocation recommendation such as, but not limited to, a working schedule or staging based, at least in part, on the identified optimum human resource allocation.

Continuing from block 910 to 912, (“Determine Supplies For The Merchant”), the merchant and/or supplier to the merchant may determine supplies (e.g., lemon cake and/or lemon pound cake ingredients as previously described). The human resources allocation recommendation may be associated with moving particular goods and/or services for the business as described with respect to the non-limiting example of a coffee shop and lemon pound cake. As should be appreciated, the non-limiting examples are just but a couple of examples and a wide variety of examples may be just as applicable such as, but not limited to, department stores, grocery stores, electronic stores, restaurants, healthcare services, legal services, any of their on-line/electronic equivalents, etc., and/or any combination thereof, and accordingly, the claimed subject matter is not limited in these respects.

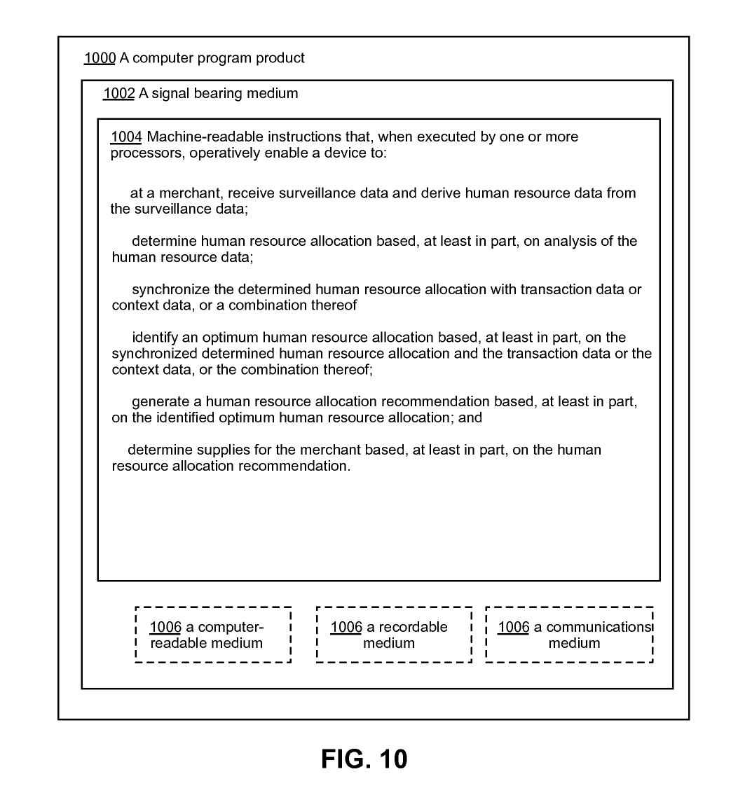

In general, the operational flow described with respect to FIG. 9 and elsewhere herein may be implemented as a computer program product, executable on a wide variety of suitable computing system, or the like. For example, a computer program product for facilitating visual analysis of transactions utilizing analytics may be provided. Example computer program products may be described with respect to FIG. 10 and elsewhere herein.

FIG. 10 illustrates an example computer program product 1000, arranged in accordance with at least some embodiments described herein. Computer program product 1000 may include machine readable non-transitory medium having stored therein instructions that, when executed, cause the machine to facilitate determination of human resource allocation and to make recommendations based, at least in part, on the determined human resource allocation according to the processes and methods discussed herein. Computer program product 1000 may include a signal bearing medium 1002. Signal bearing medium 1002 may include one or more machine-readable instructions 1004, which, when executed by one or more processors, may operatively enable a computing device to provide the functionality described herein. In various examples, some or all of the machine-readable instructions may be used by the devices discussed herein.

In some examples, the machine readable instructions 1004 may include at a merchant, receiving surveillance data and deriving human resource data from the surveillance data. In some examples, the machine readable instructions 1004 may include determining human resource allocation based, at least in part, on analysis of the human resource data. In some examples, the machine readable instructions 1004 may include synchronizing the determined human resource allocation with transaction data or context data, or a combination thereof. In some examples, the machine readable instructions 1004 may include identifying an optimum human resource allocation based, at least in part, on the synchronized determined human resource allocation and the transaction data or the context data, or the combination thereof. In some examples, the machine readable instructions 1004 may include generating a human resource allocation recommendation based, at least in part, on the identified optimum human resource allocation. In some examples, the machine readable instructions 1004 may include determining supplies for the merchant based, at least in part, on the human resource allocation recommendation, where the optimum human resource allocation may affect supplies for the merchant and/or supplier.

In some implementations, signal bearing medium 1002 may encompass a computer-readable medium 1006, such as, but not limited to, a hard disk drive, a Compact Disc (CD), a Digital Versatile Disk (DVD), a digital tape, memory, etc. In some implementations, the signal bearing medium 1002 may encompass a recordable medium 1008, such as, but not limited to, memory, read/write (R/W) CDs, R/W DVDs, etc. In some implementations, the signal bearing medium 1002 may encompass a communications medium 1010, such as, but not limited to, a digital and/or an analog communication medium (e.g., a fiber optic cable, a waveguide, a wired communication link, a wireless communication link, etc.). In some examples, the signal bearing medium 802 may encompass a machine readable non-transitory medium.

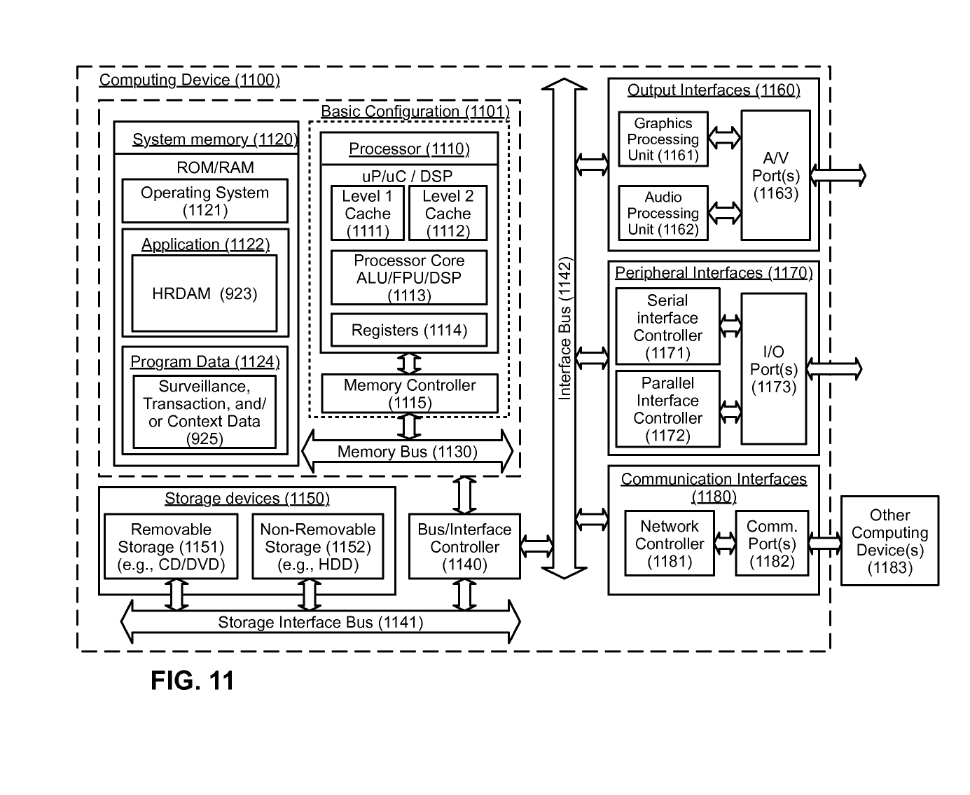

In general, the methods described with respect to FIGS. 6, 7, and 9 and elsewhere herein may be implemented in any suitable computing system. Example systems may be described with respect to FIG. 11 and elsewhere herein. In general, the system may be configured to facilitate visual analysis of transactions utilizing analytics.

FIG. 11 is a block diagram illustrating an example computing device 1100, such as might be embodied by a person skilled in the art, which is arranged in accordance with at least some embodiments of the present disclosure. In one example configuration 1101, computing device 1100 may include one or more processors 1110 and system memory 1120. A memory bus 1130 may be used for communicating between the processor 1110 and the system memory 1120.

Depending on the desired configuration, processor 1110 may be of any type including but not limited to a microprocessor (μP), a microcontroller (μC), a digital signal processor (DSP), or any combination thereof. Processor 1110 may include one or more levels of caching, such as a level one cache 1111 and a level two cache 1112, a processor core 1113, and registers 1114. The processor core 1113 may include an arithmetic logic unit (ALU), a floating point unit (FPU), a digital signal processing core (DSP Core), or any combination thereof. A memory controller 1115 may also be used with the processor 1110, or in some implementations the memory controller 1115 may be an internal part of the processor 1110.

Depending on the desired configuration, the system memory 1120 may be of any type including but not limited to volatile memory (such as RAM), non-volatile memory (such as ROM, flash memory, etc.) or any combination thereof. System memory 1120 may include an operating system 1121, one or more applications 1122, and program data 1124. Application 1122 may include human resource data analysis module (HRDAM) 1123 that is arranged to perform the functions as described herein including the functional blocks and/or actions described. Program data 9114 may include surveillance data, transaction, and/or context data 1125, and/or any combination thereof for use with HRDAM 1123. In some example embodiments, application 1122 may be arranged to operate with program data 1124 on an operating system 1121 such that implementations of facilitating identification of human resource allocation and/or recommendations regarding human resource allocation based, at least in part, on the identified human resource allocation may be provided as described herein. For example, apparatus described in the present disclosure may comprise all or a portion of computing device 1100 and be capable of performing all or a portion of application 1122 such that implementations of facilitating predicting future behavior utilizing video content analytics may be provided as described herein. This described basic configuration is illustrated in FIG. 11 by those components within dashed line 1101.

Computing device 1100 may have additional features or functionality, and additional interfaces to facilitate communications between the basic configuration 1101 and any required devices and interfaces. For example, a bus/interface controller 1140 may be used to facilitate communications between the basic configuration 1101 and one or more data storage devices 1150 via a storage interface bus 1141. The data storage devices 1150 may be removable storage devices 1151, non-removable storage devices 1152, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1120, removable storage 1151 and non-removable storage 1152 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1100. Any such computer storage media may be part of device 1100.

Computing device 1100 may also include an interface bus 1142 for facilitating communication from various interface devices (e.g., output interfaces, peripheral interfaces, and communication interfaces) to the basic configuration 1101 via the bus/interface controller 1140. Example output interfaces 1160 may include a graphics processing unit 1161 and an audio processing unit 1162, which may be configured to communicate to various external devices such as a display or speakers via one or more NV ports 1163. Example peripheral interfaces 1170 may include a serial interface controller 1171 or a parallel interface controller 1172, which may be configured to communicate with external devices such as input devices (e.g., keyboard, mouse, pen, voice input device, touch input device, etc.) or other peripheral devices (e.g., printer, scanner, etc.) via one or more I/O ports 1173. An example communication interface 1180 includes a network controller 1181, which may be arranged to facilitate communications with one or more other computing devices 1183 over a network communication via one or more communication ports 1182. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 1100 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 1100 may also be implemented as a personal computer including both laptop computer and non-laptop computer configurations. In addition, computing device 1100 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for optimizing human resource allocation comprising:
receiving surveillance data and deriving human resource data from the surveillance data;
determining human resource allocation based, at least in part, on analysis of the human resource data;
synchronizing the determined human resource allocation with transaction data or context data, or a combination thereof;
identifying an optimum human resource allocation based, at least in part, on the synchronized determined human resource allocation and the transaction data or the context data, or the combination thereof; and
generating a human resource allocation recommendation based, at least in part, on the identified optimum human resource allocation.

2. The method of claim 1, further comprising receiving the surveillance data from a plurality of video image capturing devices.

3. The method of claim 1, wherein the surveillance data includes video data or audio data, or a combination thereof.

4. The method of claim 1, wherein deriving human resource data comprises executing video content analysis (VCA) of the surveillance data.

5. The method of claim 1, further comprising identifying an optimum ratio of employees to customers or an employee specific impact on net profit, or a combination thereof based, at least in part, on the synchronized human resource data and the transaction data or the context data, or a combination thereof.

6. The method of claim 5, wherein generating the human resource allocation recommendation, further comprises generating an employee schedule configured to optimize human resource allocation based, at least in part, on the optimum ratio of employees to customers or the employee specific impact on net profit based, at least in part, on the synchronized human resource data and the transaction data or the context data, or a combination thereof.

7. The method of claim 1, wherein the human resource allocation recommendation is based, at least in part, on context data.

8. The method of claim 1, wherein the human resource allocation recommendation is based, at least in part, on the transaction data.

9. The method of claim 1, wherein determining human resource allocation further comprises identifying one or more employees or one or more customers or a combination thereof in the surveillance data based, at least in part, on facial data recognition.

10. The method of claim 1, wherein the context comprises at least one of a camera location, a camera ID, a time, a date, an item purchased, a type of establishment, weather information, a season, a transaction type, a cost, a product, a service, a duration of visit, a speed, a direction of travel, an entrance, an exit, or a gender, or any combination thereof.

11. The method of claim 1, wherein determining human resource allocation further comprises:
identifying one or more employees in the surveillance data;
identifying one or more customers in the surveillance data; and
determining one or more ratios of employees to customers during one or more time periods.

12. The method of claim 2, wherein the plurality of video image capturing devices are located in at least two different geographical locations.

13. The method of claim 1, further comprising identifying one or more employees, employee behaviors, employee locations, customers, customer behaviors or customer locations or a combination thereof based, at least in part, on video content analysis (VCA) of the surveillance data.

14. The method of claim 13, wherein the VCA includes facial recognition analysis or behavior analysis, or a combination thereof and wherein the behavior analysis is based, at least in part, on the transaction data or the context data, or a combination thereof.

15. The method of claim 14, wherein generating the human resource allocation recommendation is based, at least in part, on the behavior analysis.

16. The method of claim 11, wherein the transaction data includes net profit data and wherein synchronizing human resource data with the transaction data further comprises comparing the one or more ratios of employees to customers during the one or more time periods with the net profit data for one or more corresponding time periods.

17. The method of claim 11, wherein identifying an optimum human resource allocation, further comprises identifying an optimum ratio of employees to customers that correlates to a maximum net profit based, at least in part, on the net profit data.

18. The method of claim 17, wherein identifying an optimum human resource allocation, further comprises identifying one or more employees based, at least in part, on video content analysis and associating a percentage of net profit with each of the one or more employees to identify an employee specific impact on net profit of the one or more employees.

19. The method of claim 18, further comprising identifying the employee specific impact on net profit based, at least in part, on the context data.

20. The method of claim 19, wherein generating the human resource allocation recommendation, further comprises generating an employee schedule configured to optimize human resource allocation based, at least in part, on the optimum ratio of employees to customers and the employee specific impact on net profit based, at least in part, on the synchronized human resource data.

21. An apparatus comprising:
a processor;
a human resource data analysis module (HRDAM) communicatively coupled to the processor, the HRDAM configured to:
receive surveillance data and derive human resource data from the surveillance data;
determine human resource allocation based, at least in part, on analysis of the human resource data;
synchronize the determined human resource allocation with transaction data or context data, or a combination thereof;
identify an optimum human resource allocation based, at least in part, on the synchronized human resource data and the transaction data or the context data, or the combination thereof; and
generate a human resource allocation recommendation based, at least in part, on the identified optimum human resource allocation.

22. The apparatus of claim 21, wherein the HRDAM is further configured to receive the surveillance data from a plurality of video image capturing devices.

23. The apparatus of claim 21, wherein the surveillance data includes video data or audio data, or a combination thereof.

24. The apparatus of claim 21, wherein the HRDAM is further configured to derive human resource data by executing video content analysis (VCA) of the surveillance data.

25. The apparatus of claim 21, wherein the HRDAM is further configured to identify an optimum ratio of employees to customers or an employee specific impact on net profit, or a combination thereof based, at least in part, on the synchronized human resource data and the transaction data or the context data, or a combination thereof.

26. The apparatus of claim 25, wherein the HRDAM is further configured to generate an employee schedule as the human resource allocation recommendation, wherein the employee schedule is configured to optimize human resource allocation based, at least in part, on the optimum ratio of employees to customers or the employee specific impact on net profit based, at least in part, on the synchronized human resource data and the transaction data or the context data, or a combination thereof.

27. The apparatus of claim 21, wherein the human resource allocation recommendation is based, at least in part, on context data.

28. The apparatus of claim 27, wherein the human resource allocation recommendation is based, at least in part, on transaction data.

29. The apparatus of claim 21, wherein the HRDAM is further configured to identify one or more employees or one or more customers or a combination thereof in the surveillance data based, at least in part, on facial data recognition to determine human resource allocation.

30. The apparatus of claim 21, wherein the context comprises at least one of a camera location, a camera ID, a time, a date, an item purchased, a type of establishment, weather information, a season, a transaction type, a cost, a product, a service, a duration of visit, a speed, a direction of travel, an entrance, an exit, or a gender, or any combinations thereof.

31. The apparatus of claim 21, wherein to identify the human resource allocation, the HRDAM is further configured to:
identify one or more employees in the surveillance data;
identify one or more customers in the surveillance data; and
determine one or more ratios of employees to customers during one or more time periods.

32. The apparatus of claim 22, wherein the plurality of video image capturing devices are located in at least two different geographical locations.

33. A machine readable non-transitory medium having stored therein instructions that, in response to execution, cause a device to:
receive surveillance data and derive human resource data from the surveillance data;
determine human resource allocation based, at least in part, on analysis of the human resource data;
synchronize the determined human resource allocation with transaction data or context data, or a combination thereof;
identify an optimum human resource allocation based, at least in part, on the synchronized human resource data and the transaction data or the context data, or the combination thereof; and
generate a human resource allocation recommendation based, at least in part, on the identified optimum human resource allocation.

34. The machine readable non-transitory medium of claim 33, further having stored therein instructions that, in response to execution, cause the device to identify one or more employees, employee behaviors, employee locations, customers, customer behaviors or customer locations or a combination thereof based, at least in part, on video content analysis (VCA) of the surveillance data.

35. The machine readable non-transitory medium of claim 34, wherein the VCA includes facial recognition analysis or behavior analysis, or a combination thereof and wherein the behavior analysis is based, at least in part, on the transaction data or the context data, or a combination thereof.

36. The machine readable non-transitory medium of claim 35, wherein the human resource allocation recommendation comprises a schedule based, at least in part, on the behavior analysis.

37. The machine readable non-transitory medium of claim 33, further configured to determine human resource allocation by further having stored therein instructions that, in response to execution, cause the device to:
identify one or more employees in the surveillance data;
identify one or more customers in the surveillance data; and
determine one or more ratios of employees to customers during one or more time periods.

38. The machine readable non-transitory medium of claim 37, wherein the transaction data includes net profit data and is further configured to synchronize human resource data with the transaction data by further having stored therein instructions that, in response to execution, cause the device to compare the one or more ratios of employees to customers during the one or more time periods with the net profit data for one or more corresponding time periods.

39. The machine readable non-transitory medium of claim 38, further configured to determine human resource allocation by further having stored therein instructions that, in response to execution, cause the device to identify an optimum ratio of employees to customers that correlates to a maximum net profit based, at least in part, on the net profit data.

40. The machine readable non-transitory medium of claim 39, further configured to identify an optimum human resource allocation by further having stored therein instructions that, in response to execution, cause the device to identify one or more employees based, at least in part, on video content analysis and to associate a percentage of net profit with each of the one or more employees to identify an employee specific impact on net profit of the one or more employees.

41. The machine readable non-transitory medium of claim 40, further having stored therein instructions that, in response to execution, cause the device to identify an employee specific impact on net profit based, at least in part, on the context data.

42. The machine readable non-transitory medium of claim 41, further configured to generate the human resource allocation recommendation by further having stored therein instructions that, in response to execution, cause the device to generate an employee schedule configured to optimize human resource allocation based, at least in part, on the optimum ratio of employees to customers and the employee specific impact on net profit based, at least in part, on the synchronized human resource data.

43. An apparatus comprising:
a processor; and
a data distribution module (DDM) communicatively coupled to the processor, the DDM configured to:
capture surveillance data, transaction data, sensor data or context data, or any combinations thereof; and
provide the surveillance data, transaction data, sensor data or context data, or any combinations thereof to a human resource data analysis module (HRDAM) to be analyzed to identify optimum human resource allocation information and to generate human resource allocation recommendations based, at least in part, on the optimum human resource allocation information wherein the HRDAM is configured to:
determine human resource allocation based, at least in part on analysis of the human resource data;
synchronize the determined human resource allocation with transaction data or context data, or a combination thereof;
identify an optimum human resource allocation based, at least in part, on the synchronized human resource data and the transaction data or the context data, or the combination thereof; and
generate a human resource allocation recommendation based, at least in part, on the identified optimum human resource allocation.

44. The apparatus of claim 43, wherein the DDM is further configured to send context data or transaction data to the HRDAM.

45. The apparatus of claim 44, wherein the context data is derived from a sensor, global positioning satellite communication, a time keeper, a calendar, a weather forecast service, a traffic data service, a newsfeed, and the like or any combinations thereof.

46. A method for determining supplies for a merchant, the method comprising:
at the merchant, receiving surveillance data and deriving human resource data from the surveillance data;
determining human resource allocation based, at least in part, on analysis of the human resource data;
synchronizing the determined human resource allocation with transaction data or context data, or a combination thereof;
identifying an optimum human resource allocation based, at least in part, on the synchronized determined human resource allocation and the transaction data or the context data, or the combination thereof;
generating a human resource allocation recommendation based, at least in part, on the identified optimum human resource allocation; and
determining supplies for the merchant based, at least in part, on the human resource allocation recommendation.
